(19) United States
(12) Patent Application Publication
(10) Pub. No.: US 2014/0028439 A1
(43) Pub. Date: Jan. 30, 2014

(54) SENSOR-EMBEDDED DOOR HANDLE WITH FINGERPRINT IDENTIFICATION FUNCTION

(71) Applicant: Jack Lien, Taichung City (TW)

(72) Inventor: Jack Lien, Taichung City (TW)

(21) Appl. No.: 13/559,791

(22) Filed: Jul. 27, 2012

(51) Int. Cl. G06F 7/04

(52) U.S. Cl. 340/5.53

(57) ABSTRACT

A sensor-embedded door handle with fingerprint identification function comprises a door lock integration unit; a door handle disposed on the door lock integration unit; a door lock disposed on the door lock integration unit and interconnected with the door handle; a fingerprint sensing unit disposed on the door handle; a power supply wakeup unit disposed on the door handle; and a setup unit disposed on the door lock integration unit. The power supply wake-up unit and the fingerprint sensing unit are integrated into the door handle, so that the user can simply hold on to the door handle with one hand to wakeup the power supply wakeup unit and let the fingerprint sensing unit identify fingerprints at the same time when the user needs to open the door. Thus, the operation can be simplified to enhance the speed of locking and opening a door.

### BACKGROUND OF THE INVENTION

1. Field of the Invention

The present invention relates to a sensor-embedded door handle with fingerprint identification function which can identify fingerprint rapidly.

2. The Prior Arts

Door lock is a common and also important device in daily life. It is used for protecting the belongings and personal safety, and is installed in almost every home in the modern society. For areas with poor public security, one home may need two sets of door locks to enhance the safety.

Thanks to the development of technology and the lowering prices of electronic components and products, electronic door lock is becoming more popular. Even the general public can afford to install an additional electronic door lock to enhance home safety besides the conventional door lock. One of the advantages of electronic door lock is that conventional door key is not required anymore; instead, IC cards, fingerprint or iris identification is used for unlocking doors. However, IC cards are bulky in size which does not have an advantage over the conventional key. The iris identification requires more advanced technology and the installation cost is also higher which makes it relatively undesirable by the general public. Therefore, the most common door lock is the electronic door lock adopting fingerprint identification. Besides its convenience of not needing the conventional door key, the safety provided by the electronic door lock can also be enhanced because the fingerprint of each person is different.

A conventional electronic door lock with fingerprint identification function is shown in FIG. 1. A power supply wakeup unit 2, a fingerprint sensing unit 3 and a door handle 4 are disposed on different locations of the door lock integration unit 1. In order to use the conventional door lock with fingerprint identification function, the power supply wakeup unit 2 must be woken up first, and then a finger has to be placed on the fingerprint sensing unit 3 for passing the fingerprint identification before the door handle 4 can be turned to open a door lock 5. The steps of operation are more complicated and time spent is also longer than the conventional door lock.

In order to solve the drawbacks in the conventional technique, an electronic door lock is disclosed in the present invention which various units are integrated on a door handle.

### SUMMARY OF THE INVENTION

A primary objective of a sensor-embedded door handle with fingerprint identification function of the present invention is to improve the drawback of the conventional fingerprint-sensing door handle which requires multiple steps to open a door lock. In the present invention, a power supply wakeup unit and a fingerprint sensing unit are integrated into a door handle so that the speed of opening a door lock is faster than the conventional technique and even faster than the conventional door lock with a door key.

The sensor-embedded door handle with fingerprint identification function of the present invention comprises a door lock integration unit; a door handle disposed on the door lock integration unit; a door lock disposed on the door lock integration unit and interconnected with the door handle; a fingerprint sensing unit disposed on the door handle; a power supply wakeup unit disposed on the door handle; and a setup unit disposed on the door lock integration unit.

In the present invention, by integrating the power supply wakeup unit and the fingerprint sensing unit into the door handle, a user can simply hold on to the door handle with one hand to wakeup the power supply wakeup unit and let the fingerprint sensing unit identify a fingerprint at the same time when the user needs to open the door. Thereby, the conventional steps of operation can be simplified to enhance the speed of locking and opening a door, the enhanced speed is even faster than the conventional door locks.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a plane view of a conventional electronic door lock with fingerprint identification function;

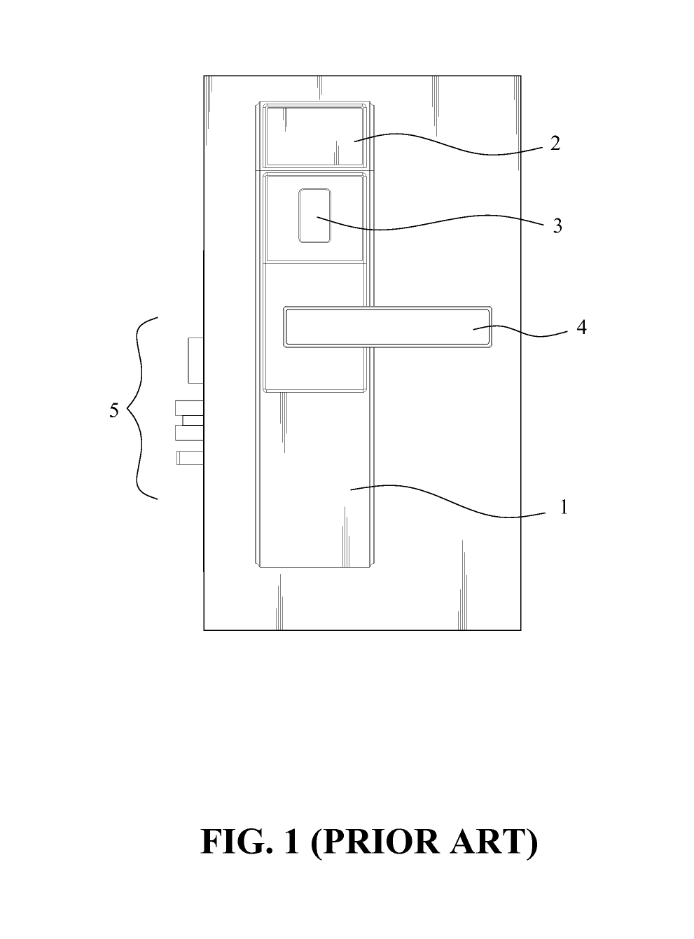

FIG. 2 is a plane view of a sensor-embedded door handle with fingerprint identification function of the present invention disposed on a door;

FIG. 3 is a perspective view of the sensor-embedded door handle with fingerprint identification function of the present invention with a front side illustrated; and

FIG. 4 is a perspective view of the sensor-embedded door handle with fingerprint identification function of the present invention with a back side illustrated.

### DETAILED DESCRIPTION OF THE PREFERRED EMBODIMENT

An embodiment of the present invention will next be described in details with reference to the accompanying drawings.

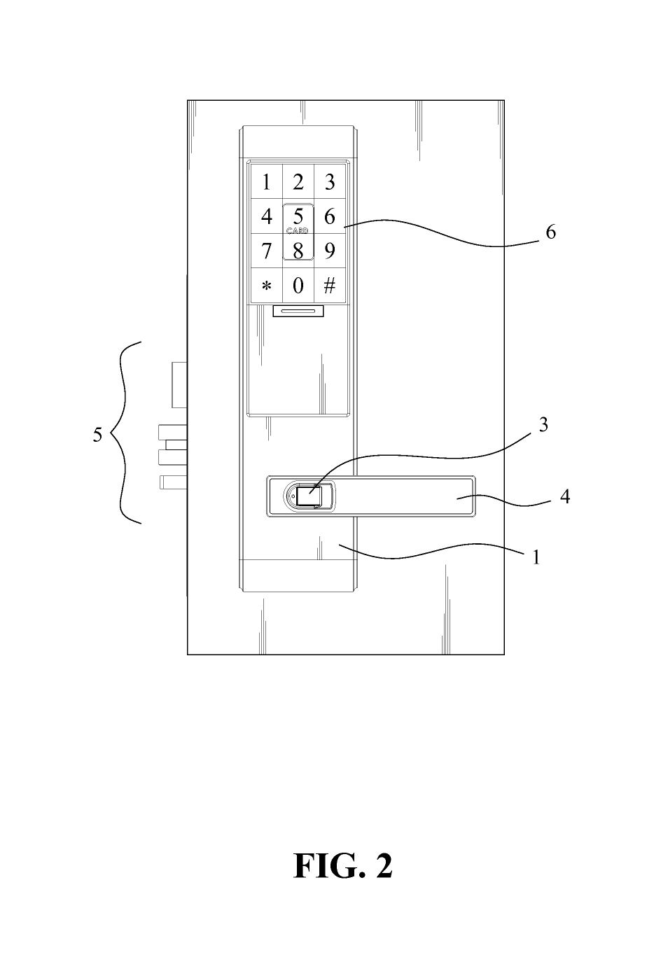

FIG. 2 is an illustration of a sensor-embedded door handle with fingerprint identification function of the present invention. The sensor-embedded door handle with fingerprint identification function comprises a door lock integration unit 1; a door handle 4 disposed on the door lock integration unit 1; a door lock 5 disposed on the door lock integration unit 1 and interconnected to the door handle 4; a fingerprint sensing unit 3 disposed on the door handle 4; and a power supply wakeup unit 2 disposed on the door handle 4.

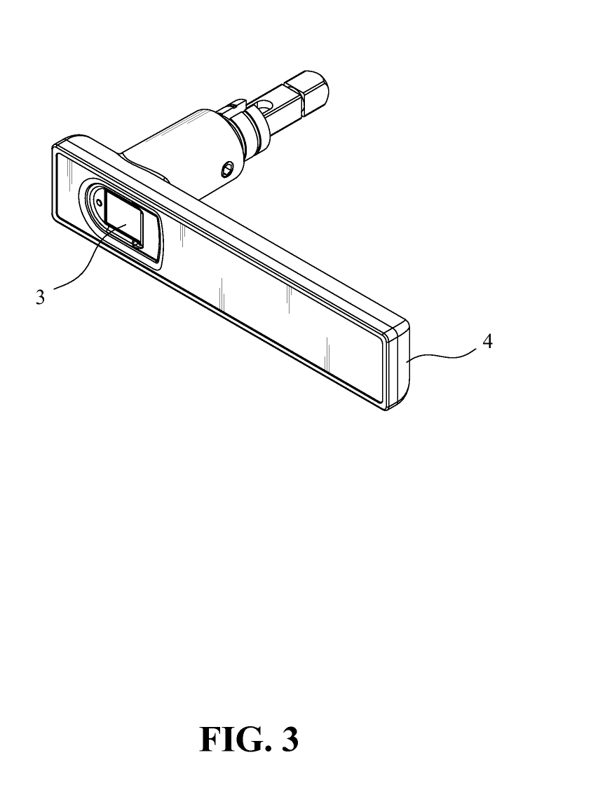

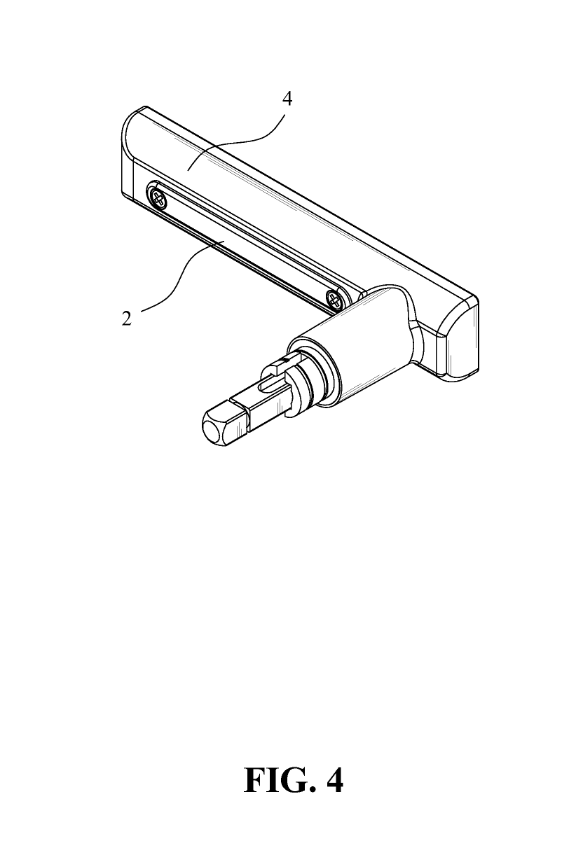

The door lock integration unit 1 is an integrated module with a chip disposed inside for processing fingerprint information. The door lock integration unit 1 can be disposed on a common door made of various materials such as a wooden door, an iron door or a copper sulfide door. The door handle 4 is disposed at a front lower end of the door lock integration unit 1 and the door lock 5 is disposed on a lateral side of the door lock integration unit 1. The door lock 5 is interconnected with the door handle 4. Thereby, a user can turn the door handle 4 to move the door lock 5 towards the door lock integration unit 1 in order to open the door. Please refer to FIGS. 3 and 4 next. The fingerprint sensing unit 3 is disposed at a front left end of the door handle 4. The power supply wakeup unit 2 is disposed on a back side of the door handle 4. When the user holds on to the door handle 4 with a hand to open the door, the four finger tips except the thumb will be in contact with the power supply wakeup unit 2. The power supply wakeup unit 2 will send a wakeup signal to the door lock integration unit 1 to actuate the door lock integration unit 1 and the fingerprint sensing unit 3. Then, the thumb of the user is pressed on the fingerprint sensing unit 3 and the fingerprint is scanned by an optical scanning structure in the fingerprint sensing unit 3. The fingerprint information is sent to the door lock integration unit 1. The fingerprint information received is compared with the fingerprint information stored in the door lock integration unit 1 to confirm if the fingerprint information of the user matches with the fingerprint information stored in the door lock integration unit 1. If they match with each other, the door lock 5 will be disengaged by the door lock integration unit 1 so that the door handle 4 can be turned by the user to move the door lock 5 open the door.

On the contrary, if the fingerprint information of the user does not match with the fingerprint information stored in the door lock integration unit 1 after the comparison, the door lock 5 will not be disengaged by the door lock integration unit 1 and the door handle 4 cannot be turned by the user to move the door lock 5 to open the door.

Furthermore, the power supply wakeup unit 2 and the fingerprint sensing unit 3 of the present invention can be embodied by means of capacitive sensing, resistive sensing, thin-filmed sensing or conventional mechanical button. Various ways of embodiment can be used to adopt different requirements based on various conditions of applications.

Please refer to FIG. 2 again. A setup unit 6 is further disposed on the door lock integration unit 1. The setup unit 6 is used for setting up the new fingerprint information before any fingerprint information is input into the door lock integration unit 1. Furthermore, when the fingerprint identification is denied or the fingerprint sensing unit 3 is malfunction, a preset unlocking password can be input into the setup unit 6 to have the door opened.

Comparing the present invention with the conventional technique, the power supply wakeup unit 2, the fingerprint sensing unit 3 and the door handle 4 in the conventional technique are disposed on different locations of the door lock integration unit 1. In order to use the conventional door lock with fingerprint identification function, the power supply wakeup unit 2 must be woken up first, and then a finger has to be placed on the fingerprint sensing unit 3 for passing the fingerprint identification before the door handle 4 can be turned to have the door lock 5 opened. The steps of operation are more complicated and the time spent is also longer than operating a conventional door lock. The advantage of the present invention lies in that, the power supply wakeup unit 2 and the fingerprint sensing unit 3 are integrated into the door handle 4. Thereby, the user can simply hold on to the door handle 4 with one hand to wakeup the power supply wakeup unit 2 and press the thumb on the fingerprint sensing unit 3 to have the fingerprint identified at the same time when the user needs to open the door. Therefore, the three steps required in the conventional technique can be simplified into one step, and both the door lock and the door can be opened more quickly than a conventional door lock.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A sensor-embedded door handle with fingerprint identification function, comprising:
a door lock integration unit;
a door handle disposed on the door lock integration unit;
a door lock disposed on the door lock integration unit and interconnected with the door handle;
a fingerprint sensing unit disposed on the door handle; and
a power supply wake-up unit disposed on the door handle.

2. The sensor-embedded door handle with fingerprint identification function as claimed in claim 1, wherein the door lock integration unit comprises a setup unit.

3. The sensor-embedded door handle with fingerprint identification function as claimed in claim 1, wherein the fingerprint sensing unit and the power supply wakeup unit are capacitive sensing buttons.

4. The sensor-embedded door handle with fingerprint identification function as claimed in claim 1, wherein the fingerprint sensing unit and the power supply wakeup unit are resistive sensing buttons.

5. The sensor-embedded door handle with fingerprint identification function as claimed in claim 1, wherein the fingerprint sensing unit and the power supply wakeup unit are thin-filmed sensing buttons.

6. The sensor-embedded door handle with fingerprint identification function as claimed in claim 1, wherein the fingerprint sensing unit and the power supply wakeup unit are mechanical buttons.
